(19) United States
(12) Patent Application Publication
(10) Pub. No.: US 2014/0041512 A1
(43) Pub. Date: Feb. 13, 2014

(54) MUSICAL SCORING

(71) Applicants: David Vincent Mastran, Great Falls, VA (US); Matthew Robert Jordan, Nashville, TN (US); Jeremy David Gerhardt Ruff, Nashville, TN (US); Larry James Little, II, Nashville, TN (US); Alan Christian Witt, Nashville, TN (US); Steve Aron Steinaway, Nashville, TN (US)

(72) Inventors: David Vincent Mastran, Great Falls, VA (US); Matthew Robert Jordan, Nashville, TN (US); Jeremy David Gerhardt Ruff, Nashville, TN (US); Larry James Little, II, Nashville, TN (US); Alan Christian Witt, Nashville, TN (US); Steve Aron Steinaway, Nashville, TN (US)

(73) Assignee: QuaverMusic.com, LLC, Nashville, TN (US)

(21) Appl. No.: 13/569,627

(22) Filed: Aug. 8, 2012

(51) Int. Cl. G09B 15/02

(52) U.S. Cl. 84/483.2

(57) ABSTRACT

A musical scoring method includes providing a musical scoring interface; receiving a user defined musical curve input; rendering a musical curve based on the user defined musical curve input; and rendering notes on the musical curve to form a musical score capable of playback.

### BACKGROUND

Musical scoring refers to the process, and corresponding systems that enable the process, of composing music. A musical score is a written form of a musical composition. Individuals interested in composing music traditionally have to spend many hours learning the basics of musical composition and musical notation. Traditional musical composition involves taking pen to paper, often in accompaniment to playing a musical instrument, such as a piano. Novices, including children may find this process intimidating.

Computer or software-based systems and methods exist to generate musical scores. One such system is known as a scorewriter, and there are many commercial scorewriters. In general, scorewriters are based on traditional music notation. Scorewiters use graphical symbols representing durations in sound and silence, along with symbols for dynamics, articulations and tempo. Some scorewriters allow a user to import or create their own symbols for use in scoring. One scorewriter variant uses a multi-track recorder metaphor as the main interface, consisting of multiple tracks and track segments. Individual tracks can be edited using a graphic notation in the form of a piano-roll guided input for the control of MIDI-based hardware or software instruments. Another variant allows the user to score parts using traditional notation, using the graphic notation of the piano roll and to record acoustic or electronic instruments in real time alongside the existing scores.

In the above described scorewriter variants, a user employs a computer keyboard and mouse for input control or employs a MIDI-based keyboard for data entry that is later edited using traditional notation or piano-roll based notation.

However, scorewriters still require detailed knowledge of musical composition and musical notation, and thus are not ideal for teaching novices the rudiments of musical scoring.

### DESCRIPTION OF THE DRAWINGS

The detailed description refers to the following figures in which like numerals refer to like items, and in which:

FIG. 1 illustrates an example environment in which a musical scoring system operates;

FIG. 2 illustrates an embodiment of a musical scoring system.

FIG. 3 illustrates an example user interface in which the system of FIG. 2 displays a musical score based on a drawing input;

FIGS. 4-6 illustrate example musical scores produced by the system of FIG. 2;

FIG. 7 is a flow chart that illustrates an example musical scoring method executed by the musical scoring system of FIG. 2; and

FIG. 8 is a flowchart illustrating an example playback executed by the musical scoring system of FIG. 2.

### DETAILED DESCRIPTION

Musical scores typically rely on a well-known system of music notation. The system may use a five-line staff to record the notes. In general terms, notes represent the relative pitch of a sound. Notes may also represent the relative duration of a sound. Pitch is shown by placement of notes on the staff and duration is shown with different note values and additional symbols such as dots and ties. In terms of duration, notes range from double whole notes (breve—long notes) to eighth notes (quaver—short notes), and smaller. Notation is read from left to right, which makes setting music for right-to-left scripts difficult.

A staff of written music generally begins with a clef, which indicates the position of one particular note on the staff. The treble or G clef was originally a letter G and it identifies the second line up on the five line staff as the note G above middle C. The bass or F clef shows the position of the note F below middle C. Notes representing a pitch outside of the scope of the five line staff can be represented using ledger lines, which provide a single note with additional lines and spaces.

Following the clef, the key signature on a staff indicates the key of the piece by specifying that certain notes are flat or sharp throughout the piece, unless otherwise indicated. Following the key signature is the time signature. Measures (bars) divide the piece into groups of beats, and the time signatures specify those groupings.

Directions to the musician regarding matters such as tempo, dynamics and expression appear above or below the staff.

Construction of a musical score can be laborious. More recently, computer software has been developed to provide a more convenient and flexible musical composition method. Whether written directly by a composer, or written with the aid of computer programming, musical scoring relies on well-established rules, symbols, and notations, such as those described above, to convey the essential features, such as pitch, tone, and tempo, of their musical scores. For a composer, developing skill in musical scoring is time consuming, and usually requires guidance from an expert instructor. Even when utilizing computer programming, such as scorewriters, much training and experience is needed to generate a good musical score. Thus, current musical scoring methods and systems are not ideal, or even useable by novices, including young children, who are being introduced to musical composition.

To address shortcomings with current musical scoring methods and systems, particularly with self-learning methods and systems, disclosed herein are methods and systems for translating a drawing into a musical score with musical notations. The methods and systems are ideal for self-learning, and are particularly well-suited for novice composers, including young children. The methods and systems translate a curve into a musical score that is populated with musical notation according to well-established musical scoring rules and unique processes. The methods and systems provide a visual representation of the notated musical score. The musical score provides an interactive learning device that composers may use to develop musical composition skills.

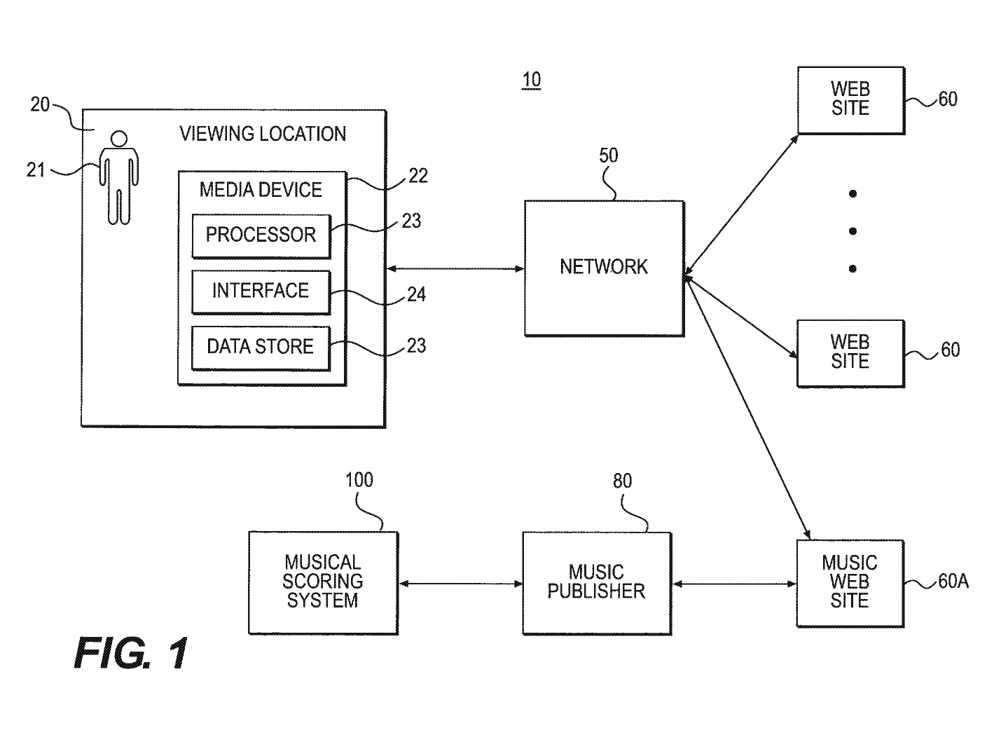

FIG. 1 illustrates an environment in which an example musical scoring system operates. In FIG. 1, environment 10 includes viewing location 20, communications network 50, Web sites 60, music publisher 80, which operates musical Web site 60A, and musical scoring system 100, which is provided by the musical publisher 80.

The systems and methods enable a viewer 21 to make a drawing on an interface and have the drawing translated into musical notation. The viewer 21 inputs the drawing as a line or curve into the computer using a computer mouse, touch interface, or other interface method to control a software drawing tool. In an example, after the viewer 21 has completed the drawing, another software drawing tool adds appropriate musical notation as an overlay to the viewer's drawing. In another example, the musical notation is added as the viewer 21 draws the curve. The musical notation and the viewer's drawing are displayed in the interface as a musical score. To modify the musical score, the viewer 21 may add to the drawing by extending the curve and musical notation will be added to the extended drawing. The viewer 21 may also choose to erase portions of the drawing, and the corresponding notation also will be erased.

The translation process takes into account many factors and adjustments to the raw input that improve the aesthetic musical quality of the notation output. For example, the systems and methods allow for reducing the occurrence of dissonance and also allow for the spontaneous organization of musical chords. The systems and methods apply rules to ensure that the notation is readable, useful, and musically accurate. The systems and methods allow the rendered notation to be manipulated in various ways. The musical score may be played back via an audio output on the same device or be converted to another audio or data file format (such as MP3 or midi). The viewer 21 can choose to manipulate the music tempo, and timbre, or any other configurable parameter.

The viewing location 20 may be any location capable of receiving signals over the communications network 50. In an embodiment, the viewing location 20 is a private home from which the viewer 21 uses media device 22 to access the Web sites 60 and more specifically musical Web site 60A. In another embodiment, the viewing location 20 may be at a school, a kiosk, or any public or private facility. Finally, the viewing location 20 need not be fixed geographically, and the viewing location 20 may be a moving location such as in a car, train, or airplane.

The media device 22 may include processor 23, interface 24, and data store 25. In an embodiment, the data store 25 stores components of musical scoring system 100. In this embodiment, as is described below, the processor 23 may execute machine code comprised in the musical scoring system, and may display data and information related to the execution, on the interface 24. Furthermore, in this embodiment, the musical scoring system components may be transferred to the data store 25 by copying from a computer readable medium such as an optical disk, or by download from the musical Web site 60A.

In an embodiment, the interface 24 may include touch-sensitive screen, and the viewer 21 may provide inputs to the system 100 through the touch-sensitive screen of the interface 24.

The media device 22 may be fixed in position in the environment 10 or may be a mobile media device. In an embodiment, the media device 22 may be an Internet connected “smart” television, a “basic” or “smart” television connected to a set top box (STB), a Blu-ray™ player, a game box, an Internet-connected box, or a radio, for example. In another embodiment, the media device 22 may be a television that has no Internet connectivity. A television that includes Internet connections may be referred to as an ITV. In another embodiment, the media device 22 may be a tablet, a smart phone, a laptop computer, or a desk top computer, for example.

Among other functions, the media device 22 may interface with the Web sites 60 using a browser, and may be used to execute specific applications that use data and/or services at the Web sites 60. When the media device 22 is turned on, a viewer 21 using the media device 22 may sign on with a publisher or Web site operator to access the Web sites 60. In some cases, the media device 22 may sign on automatically using previously provided and stored credentials or other authentication information. In a similar fashion, the media device 22 may interface with the musical Web site 60A.

The network 50 may be any communications network that allows the transmission of signals, media, messages, voice, and data from the Web sites 60 and the musical Web site 60A to the viewer 21, including linear broadcast (over-the-air, cable, and satellite) television, on-demand channels, over-the-top media, including streaming video, movies, video clips, and games, and text, email, and still images, and transmission of signals, media, messages, voice, and data from the viewer 21 to the Web sites 60 and the musical Web site 60A. The network 50 may include the Internet, cellular systems, and other current and future mechanisms for transmission of electronic content. The network 50 may be both wired and wireless.

The Web sites 60 provide Internet-based content including specific applications for display and execution at the media device 22. In an embodiment, the musical Web site 60A includes as an application, musical scoring system 100.

The publisher 80 operates musical Web site 60A. Among other features, the musical Web site 60A provides, in various formats, musical scoring system 100. For example, the musical scoring system 100 may be an application residing at the Web site 60A, and the visitor 21 accesses the musical scoring system 100 using a browser on the media device 22. In another example, the musical scoring system is an application than may be downloaded to a media device such as a smart phone or tablet. In another example, the musical scoring system 100 may be programming that is downloaded to a lap top computer. In still another example, the musical scoring system 100 may be provided from the publisher 80 to the visitor 21 by mailing the visitor 21 a computer readable storage device, such as a DVD on which the musical scoring system 100 is encoded. The actual contents of the musical scoring system 100 may vary depending on which of the above formats it is embodied.

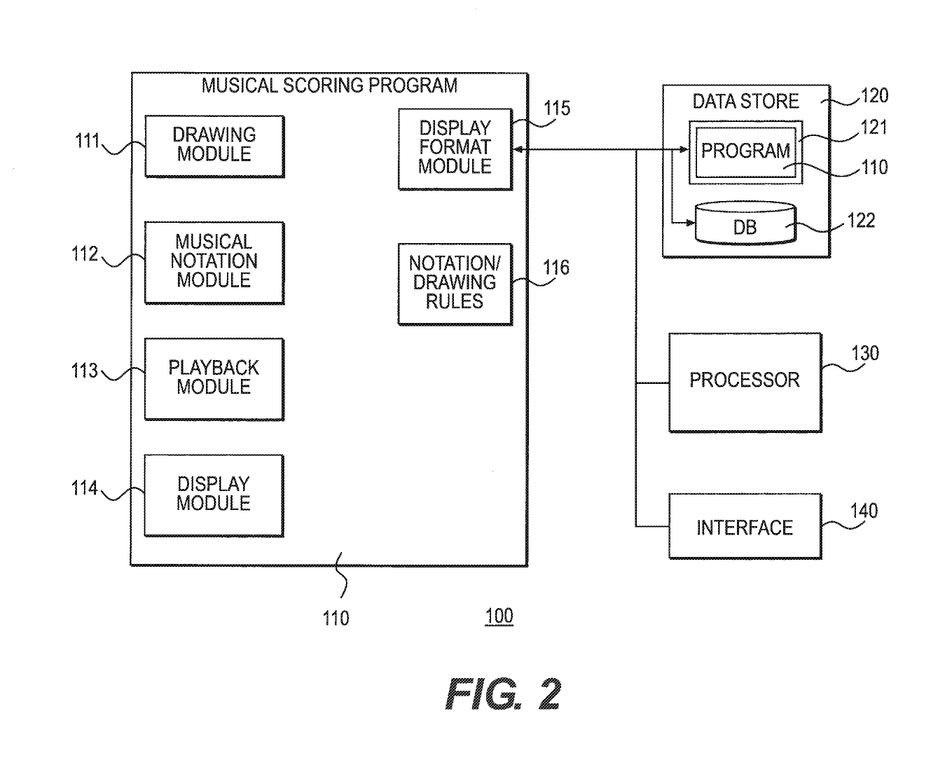

FIG. 2 illustrates an embodiment of the musical scoring system 100 shown in FIG. 1. In FIG. 2, musical scoring system 100 is illustrated as a Web-based application embodied at the musical Web site 60A. The system 100 includes musical scoring program 110, data store 120, processor 130, and interface 140.

The data store 120 may include a computer readable storage device 121 on which is stored the musical scoring program 110 and a database 122 that stores information related to execution of the program 110. The processor 130 may execute the program 110. The interface may allow visitors 21 to interact with the system 100.

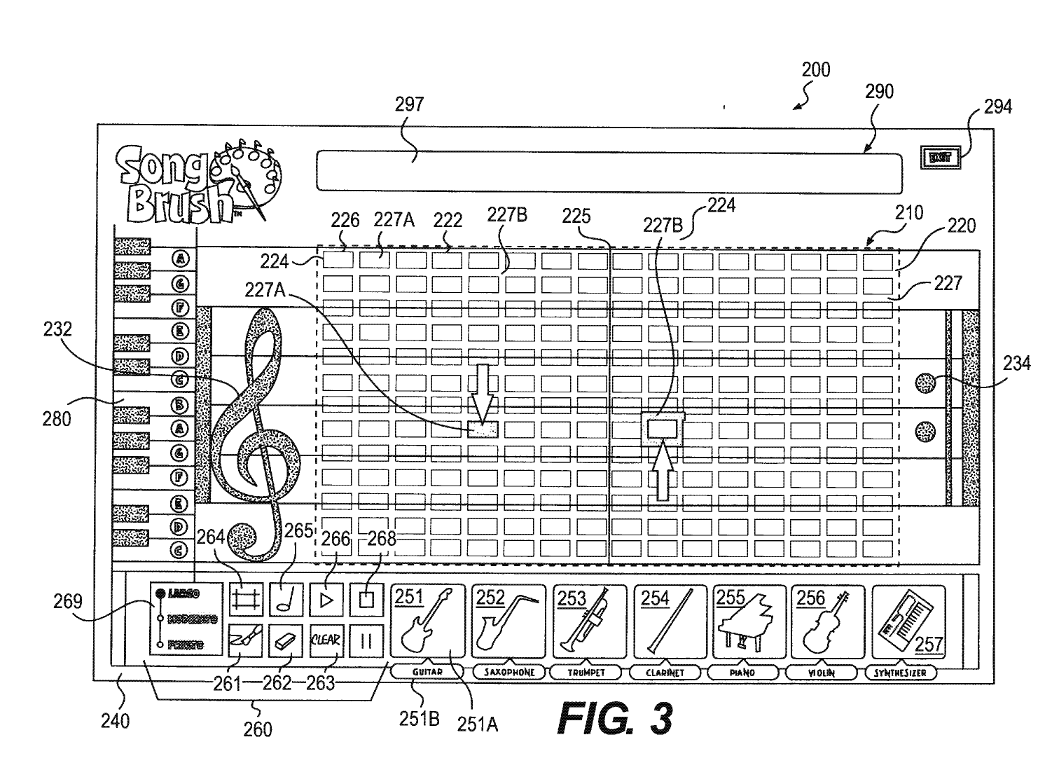

The musical scoring program includes drawing module 111, musical notation module 112, playback module 113, display module 114, display format module 115, and notation/replay rules 116. The drawing module 111 includes specific tools and features that allow a visitor 21 to draw a curve that in turn may be populated with appropriate musical notation. The musical notation module 112 may populate the curve with the appropriate musical notation to create a musical score. The playback module 113 may playback the musical score. In addition, the playback module 113 may provide the capability to download and/or print a copy of the musical score. The display module 114 includes tools that allow the visitor 21 to generate a display of the musical score. The display format module 115 allows the visitor 21 to select various display formats. Finally, the notation/replay rules 116 include rules for musical annotation and vocal playback of the musical score. These and other features and functions of the musical scoring program 110 are described in more detail with respect to FIG. 3.

FIG. 3 illustrates an example musical interface in which the system 100 of FIG. 2 displays a musical score based on a drawing input. In FIG. 3, musical interface 200 includes display area 210, control panel 240, reference panel 280, and interface control area 290. The system 100 operates to allow a viewer 21 to render one or more curves on the display area 210. Each curve may be continuous or discontinuous. Each curve may include curve segments. The curve segments may be vertical or horizontal, or a combination of vertical and horizontal. The system 100 then populates the rendered curves with musical notation. The system 100 also provides audio playback corresponding to the musical notation. The system 100 may include specific rules for forming notes and playing back notes for each curve segment.

The display area 210 includes staff 220 (illustrated by the dotted lines, which may not be visible to a viewer 21 of the interface 200). The staff 220 is divided by bar 225 into measures 222 and 224. In FIG. 3, the bar 25 is illustrated as a bar line, which may be a default setting. Each of the measures 222 and 224 is divided into columns 226 and rows 228. The columns 226 and rows 228 form a grid 227 of detection areas 227A and threshold areas 227B. Depending on operation of a grid control on the control panel 240, as described below, the grid 227 of detection areas 227A and threshold areas 227B may reside “in the background” and is not visible to a viewer 21, or may appear in the display area 210. As is described below, when a curve is drawn through a detection area 227A, the program 200 will place an appropriate musical note in the detection area 227A. However, the program 200 does not place a musical note in a threshold area 227B. The grid 227 extends horizontally in a positive (+) X-direction from the left hand side of the staff 220 and vertically in the +Y-direction from the bottom of the staff 220. The displayed staff 220 includes five rows 228, which in an example, is a default setting, and is a normal form for a musical score sheet. Above and below the rows 228 are ledger areas. At either end of the staff 220 are clef 232 and repeat symbol 234. The illustrated clef is a G or treble clef, which may be a default clef. However, other clefs may be displayed at the interface 200. For example, a visitor 21 may hover a cursor over the clef 232 and available clefs may be displayed. The visitor 21 then may click on a desired clef (e.g., a bass or F clef).

The displayed staff 220 may be a default view. The displayed staff 220 may be expanded both vertically and horizontally. For example, a visitor 21 may add additional pitch lines above or below the displayed grid 227 to allow for higher and lower pitch sounds. The staff 220 may be expanded horizontally to increase the length of the musical score. When the staff 220 is expanded vertically, the display may shrink in size (zoom out) so that the entire pitch range is displayed without scrolling. When the staff 220 is expanded horizontally, the display may remain at its original scale, and the display may scroll to allow viewing the entire musical score. Scrolling and zoom in/zoom out buttons may appear when these expansion features are selected.

The control panel 240 includes instrument section 250 and drawing/playback controls 260. The instrument section 250 includes instrument buttons 251-257, one for each of a number of musical instruments as shown. However, the instrument section 250 is not limited to the illustrated instrument buttons, and more, fewer, or different instrument buttons may be provided. Each of the instrument buttons 251-257 may be active, meaning an instrument button may be selected, and an audio playback of the composed musical score will appear to emanate from the musical instrument selected by touching one or more of the buttons 251-257. In addition, as is discussed below, selection of an instrument button from the instrument buttons 251-257, and subsequent operation of the drawing controls, allows a viewer 21 to render a curve on the staff 210 in a unique color. The instrument buttons 251-257, in an embodiment, include not only an icon (e.g., 251A for a guitar) and corresponding label (e.g., 251B), but the color of each of the instrument buttons 251-257 matches the color of the rendered curve. As is explained below, a viewer 21 may populate the staff 210 with multiple curves, where each curve represents a distinct instrument, or each curve represents multiple instruments of the same type. For example, the system 100 may generate a musical score for five unique instruments rendered as five differently-colored curves. Alternately, the system 100 may generate a musical score for two or more of the same instruments, such as two or more violins, in which case, in an embodiment, the system 100 would render two or more curves of the same color on the staff 210. In another embodiment, a second staff may be combined with the staff 220 so that multiple musical instruments may be used in the musical score.

The drawing/playback controls 260 include brush button 261, erase button 262, clear button 263, grid button 264, note button 265, play button 266, pause button 267, stop button 268, and tempo button 269. When activated, the brush button 261 allows the visitor 21 to draw a curve on the staff 220 by moving a cursor vertically and horizontally over the display area. When the erase button 262 is selected, the visitor 21 can move the cursor along the curve to erase the curve. The erase feature may operate in any direction along the curve. The clear button 263, when selected, clears the curve and any notes from the staff 220. The note button is used to populate the display area 210 with appropriate musical notation, with notes placed along the curve where the curve intersects a detection area 227A. The play button 266, pause button 267, and stop button 268 are used, respectively, to playback the musical score, pause the playback, and end the playback. The tempo button 269, which in the example illustrated is a slide bar, controls the speed of play back. For example, the tempo button 269 may be used to select between largo (slower speed) and presto (higher speed) playback. Other tempos may be used with the tempo button 269.

Other features may be incorporated into the musical scoring program 200. For example, during play back, each note, as it is sounded, may be highlighted on the staff 220. The program 200 may allow the visitor 21 to save a copy of the musical score, either at the Web site 60A, or another location, and may allow the musical score to be printed. For example, the visitor 21 may print the musical score at a printer located at the viewing location 20. The program 200 may allow the visitor 21 to send a copy of the musical score to an Internet address or by email.

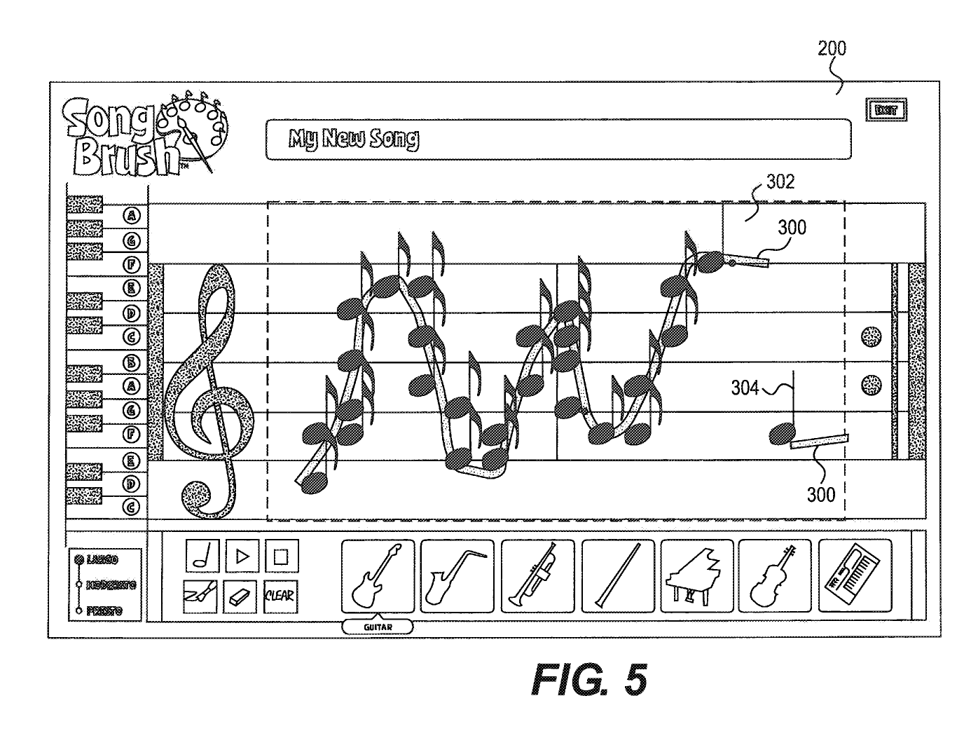

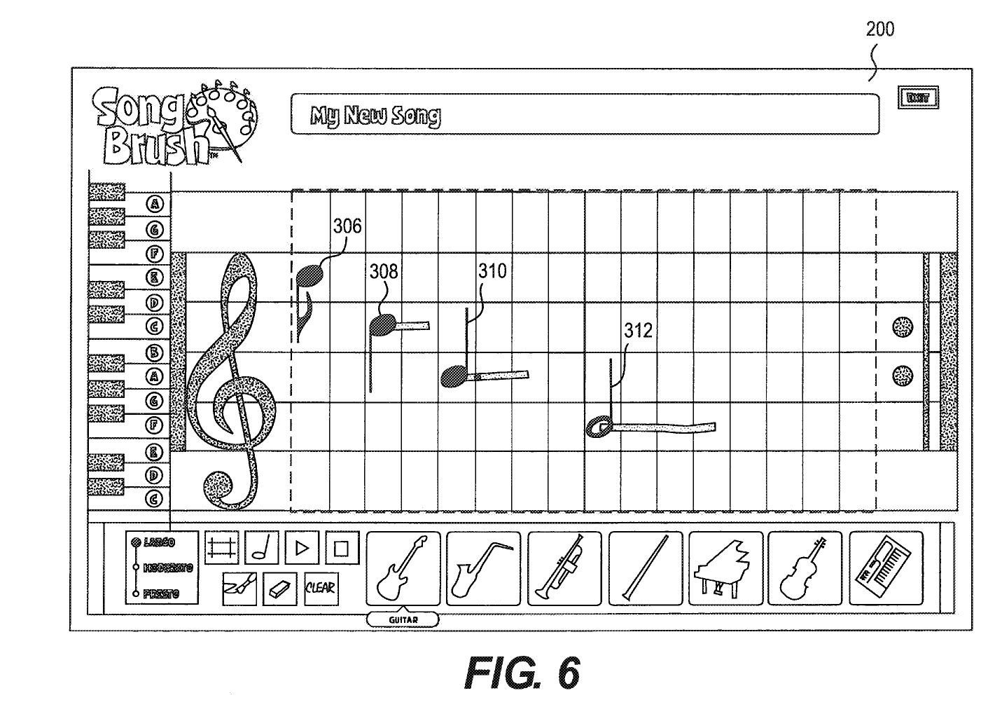

When converting a visitor-provided curve into a musical score with musical notations, the musical notation module 112 may take into account potential differences in duration for the notes. The module 112 takes into account the number of columns 226 that the curve traverses at a given pitch (or row of detection areas 227A). For example, if the chosen resolution of the display area 210 is an eighth note (½ beat), then each measure 222/224 has 8 columns. If the visitor 21 draws a curve that crosses two or more consecutive columns 226 while staying on the same pitch, the duration of that pitch can be adjusted to correlate with the number of consecutive columns 226 that curve crosses. In a more specific example, if a visitor 21 draws a curve that crosses pitch 1 in columns 1, 2, and 3, the notation module 112 will show a note on pitch 1 in column 1, and adjust the duration of the note to be equal to three eighth notes (the displayed staff 220 having an eighth note resolution), which in musical notation is a dotted quarter note. See FIGS. 5 and 6. This duration rule applies to consecutive columns 226 being crossed on the same pitch (or row 228). Thus, if the visitor 21 draws a curve that crosses pitch 1 in column 1 and pitch 2 in column 2, the notation module 112 will render an eighth note at pitch 1, column 1 and another eighth note at pitch 2, column 2.

The output of the musical notation module 112 may be supplied to the playback module 113 for playback, as described below. The output also may be stored as an electronic file (e.g., music XML or MIDI) and exported for use with other applications, may be stored as a non-editable document (e.g., pdf), or may be printed.

The playback module 113 applies rules from the notation/drawing file 116. Two examples are rules that may be invoked when determining which pitches should be sounded simultaneously: In musical scoring, if notes appear directly above or below each other (i.e., in the columns 226) then the notes are to be played simultaneously. If a visitor 21 were to draw a vertical line from pitch 1 to pitch 9 on the staff 220, and the notes were played, the sound would not be pleasing to the ear. To avoid this situation, the playback module 113 applies rules from the notation/drawing file 116 to produce a sound that is pleasing to the ear and is not cacophonous.

The first such rule may be termed the “Every Other Pitch” Rule. Recalling that on the staff 220, with pitches designated by both horizontal lines and the spaces between the horizontal lines, if a visitor 21 draws a vertical curve, the pitches crossed by the curve may be numbered sequentially starting at the bottom and counting up. The bottom pitch is designated pitch 1, no matter where the curve starts. The next pitch up is pitch 2, the one above that is pitch 3, and so on. The Every Other Pitch Rule says that the playback module 113 may never play pitches that are numerically adjacent to each other. For example, pitches 1 and 2 may never be played together (i.e., simultaneously), just as pitches 5 and 6 may never be played together.

As a further example, assume a vertical curve crosses pitches 1, 2, 3, 4, and 5. The playback module 113 will play pitch 1, but will not play pitch 2, because pitch 1 is already being played. Moving up the curve, the playback module 113 will play pitch 3 since the pitch below (pitch 2) is silenced. The playback module 113 will not play pitch 4 because the pitch directly below (pitch 3) is being played. Finally, the playback module 113 will play pitch 5 since the pitch directly below (pitch 4) is silent.

A second rule may be termed the “Skip the Seventh Pitch” Rule, which may be illustrated by example. Assume a vertical curve from pitch 1 up to pitch 7. Based on the Every Other Pitch Rule, the playback module 113 would play pitches 1, 3, 5, and 7, while silencing pitches 2, 4, and 6. The Skip the Seventh Pitch Rule means that if pitches 1, 3, and 5 are already playing, then the payback module 113 will not play pitch 7.

A final example will illustrate application of the two replay rules stated above. Again, assume a vertical curve starting at pitch 1 and extending to pitch 11 (in a vertically extended staff, or in the case ledger lines are used). The playback module 113 plays pitches 1, 3, 5, 8, and 10. The module 113 skips pitches 2, 4, and 6 because of the Every Other Pitch Rule and skips pitch 7 because of the Skip the Seventh Pitch Rule. Beginning with pitch 8, the module 113 applies the Every Other Pitch Rule 1 and plays pitches 8 and 10 and skips pitches 9 and 11.

The playback module 113 also observes a Duration Rule in which notes are played for the duration indicated on the staff 220. Thus, in the example of an eighth note staff 220, when three columns 226 are crossed at a same pitch, the note has a duration of three eighth notes, and the playback module 113 plays the note for this duration.

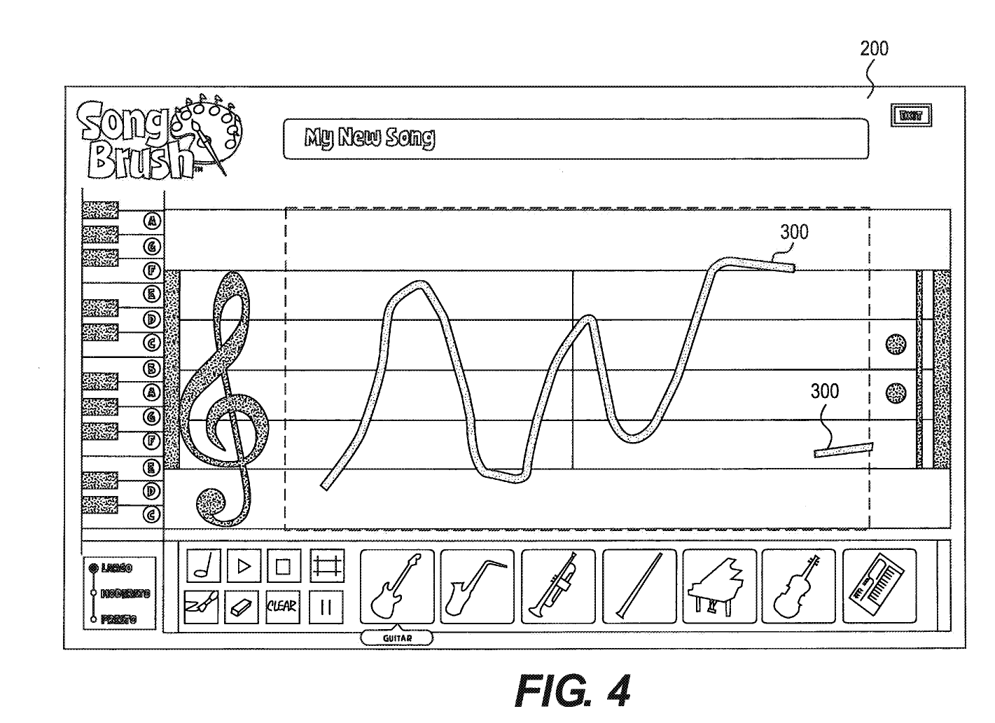

FIGS. 4-6 illustrate example interface displays produced by the system 100. FIG. 4 illustrates features of the interface 200 with a curve 300 produced by a visitor 21. As can be seen, the curve 300 is not continuous. At least a portion of the curve 300 has the shape of a sine curve. The upper right-hand portion and lower right-hand portion of the curve 300 appear to cross more than one column (the grid is not illustrated) at the same pitch.

FIG. 5 illustrates the interface 200 with the curve 300 populated with musical notes. As can be seen, for most of the curve, the notes are eighth notes. However, notes 302 304 reflect the fact that the curve 300 crosses multiple columns at a same pitch where these two notes are placed.

FIG. 6 illustrates another example of application of the Duration Rule when rendering notes on a curve. Notes 306, 308, 310, and 312 are shown having different durations based on the curve segments drawn by a visitor 21.

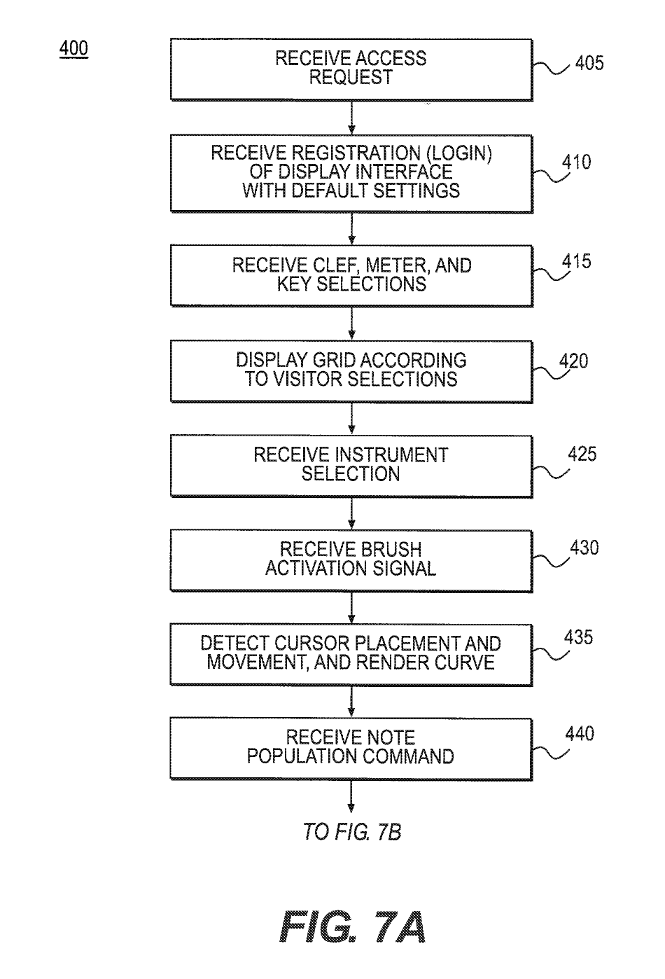

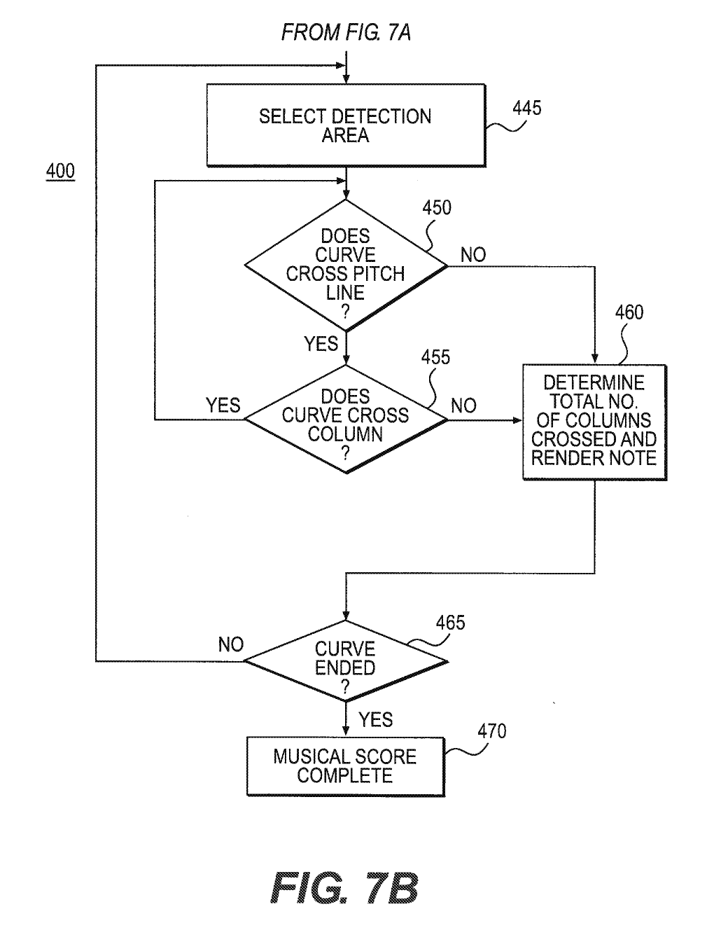

FIG. 7 is a flow chart that illustrates an example musical scoring method executed by the musical scoring system 100 of FIG. 2 and the interface 200 of FIG. 3 to render curve 300 with notes of FIG. 5. In FIG. 7, musical scoring and method 400 begins in block 405 when the interface 140 receives an access request from a visitor 21. In block 410, the interface 140 receives a registration (i.e., login) from the visitor 21 and in response displays the interface 200. The display of the interface 200 may include defaults settings for the staff 220, clef 232, and key 238. In block 415, the display format module 115 receives, from the visitor 21, a selection for the clef 232, meter 236, and key 238. In block 420, the display module 114 displays grid 227 on the interface 200 according to the selections of the visitor 21. In block 425, the playback module 113 receives a selection of the visitor 21 for an instrument according to the instrument buttons 251-257. In block 430, the drawing module 111 receives an activation signal from the brush button 261. In block 435, the drawing module 111 detects placement and subsequent movement of a cursor in the display area 210 and renders the curve 300 in a color corresponding to the selected instrument in block 425.

In block 440, the notation module 112 receives a command to populate the rendered curve 300 with musical notation. In block 445, the module 112 selects the first (i.e., the lower left-most) detection area 227A in which a segment of the curve 300 has been rendered, and for which no note is currently rendered, and traces the curve 300. In block 450, the notation module 112 determines if the curve 300 crosses a pitch line (i.e., a row 228). If the curve 300 does not cross a pitch line, the method 400 moves to block 460. If, however, the curve crosses a pitch line, the method 400 moves to block 455 and the module 112 determines if the curve 300 crosses a column 226. If the curve 300 crosses a column 226, the method 400 returns to block 450. In block 460, the notation module 112 determines a number of columns 226 crossed between pitch lines and renders a note signifying the appropriate duration. For example, if in blocks 450-460, the module 112 determines that three columns 226 were crossed, the notation module 112 renders a note with a duration of three eighth notes (or, in musical terms, a dotted quarter note). The method 400 then moves to block 465 and determines if the curve 300 has ended (note that the curve 300 need not be continuous). If the curve 300 has not ended, the method 400 returns to block 445 and the notation module 112 selects the next detection area along the curve 300 for which a note has not been rendered. The method of blocks 445 to 465 then repeats until the end of the curve 300 is reached. In block 465, if the module 112 determines the curve 300 has ended, the method 400 moves to block 470 and the musical score is complete and ready for playback.

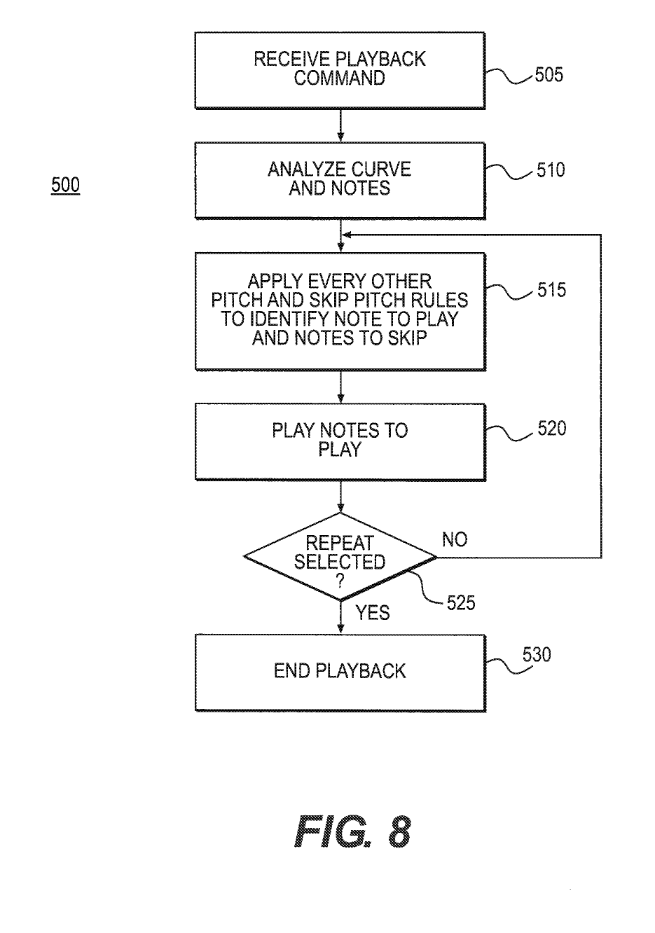

FIG. 8 is a flowchart illustrating an example playback executed by the musical scoring system of FIG. 2. In FIG. 8, playback method 500 begins in block 505 when the playback module 113 receives a signal to play the musical score currently displayed on the staff 220. In block 510, the playback module 113 analyzes the curve 300 and the noted rendered thereon to determine which rules from the notation/playback rules 116 to apply during the playback. In block 515, the playback module applies the Every Other Pitch Rule and the Skip the Seventh Pitch Rule to identify notes to play and notes to skip. In block 520, the playback module 113 plays the notes from the first pitch to the last pitch on the staff 220. In block 525, the playback module 113 determines if a repeat playback is selected (which, in an example, may be the default setting). If repeat is selected, the method 500 returns to block 515. If repeat is not selected, the method 500 moves to block 530 and the playback ends.

The preceding disclosure refers to a number of flow charts and accompanying descriptions to illustrate the embodiments represented in FIGS. 7 and 8. The disclosed devices, components, and systems contemplate using or implementing any suitable technique for performing the steps illustrated in these figures. Thus, FIGS. 7 and 8 are for illustration purposes only and the described or similar steps may be performed at any appropriate time, including concurrently, individually, or in combination. In addition, many of the steps in these flow charts may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on a non-transitory computer storage medium for execution by one or more processors. A computer storage medium can be, or can be included in, a computer-readable storage device, a computer-readable storage substrate, or a random or serial access memory. The computer storage medium can also be, or can be included in, one or more separate physical components or media such as multiple CDs, disks, or other storage devices.

The herein disclosed methods can be implemented as operations performed by a processor on data stored on one or more computer-readable storage devices or received from other sources.

As used herein, the term processor encompasses all kinds of apparatus, devices, and machines for processing data, including by way of example a programmable processor, a computer, a system on a chip, or multiple ones, or combinations, of the foregoing. The processor can include special purpose logic circuitry, e.g., an FPGA (field programmable gate array) or an ASIC (application-specific integrated circuit). The processor also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, module, engine, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

To provide for interaction with an individual, the herein disclosed embodiments can be implemented using an interactive display, such as a graphical user interface (GUI). Such GUI's may include interactive features such as pop-up or pull-down menus or lists, selection tabs, scannable features, and other features that can receive human inputs.

The computing system disclosed herein can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

We claim:

1. A musical scoring method, comprising:
providing a musical scoring interface;
receiving a user defined musical curve input;
rendering a musical curve based on the user defined musical curve input; and
rendering notes on the musical curve to form a musical score capable of playback.

2. The method of claim 1, further comprising playing the musical score.

3. The method of claim 2, wherein the musical score comprises a curve segment crossing a plurality of pitches in a column, the method comprising:
playing every other note in the curve segment; and
skipping a note at a seventh pitch of the curve segment.

4. The method of claim 2, wherein the musical score comprises a curve segment crossing a plurality of columns at a single pitch, the method further comprising:
setting a duration of a note at a beginning of the single pitch to reflect a number of columns crossed;
rendering the note at a beginning of the single pitch to reflect the duration; and
playing the note for the set duration.

5. The method of claim 2, further comprising receiving user-selected musical functions, wherein the musical functions determine the note rendering and the note playback.

6. The method of claim 5, wherein the selected musical functions include a linear note reference, a clef, a pitch range, meter, tempo, an instrument, a key, and a repeat function.

7. The method of claim 6, further comprising:
receiving selections for multiple instruments;
receiving multiple musical curve inputs, one for each of the multiple instruments; and
rendering multiple musical curves, one for each curve input, wherein each musical curve for a unique instrument is rendered in a unique color.

8. The method of claim 7, wherein playing the musical score comprises playing the musical score according to each of the selected instruments simultaneously.

9. The method of claim 6, wherein the linear note reference comprises a segment of a piano keyboard, wherein selection of the clef determines what segment of the piano keyboard is used, the method further comprising displaying the linear note reference.

10. The method of claim 1, further comprising storing the musical score as an exportable file type.

11. A musical scoring interface for generating a musical score, comprising:
a musical score display area, comprising:
a staff on which;
a user-defined musical curve is input, and
musical notes are rendered according to the user-defined musical score, and
a clef;
a control section, comprising:
drawing controls whereby a user draws the user-defined musical score,
musical instrument controls, whereby the user selects a musical instrument, and
playback controls, whereby the user controls playback of the musical score; and
a reference section comprising a linear note reference.

12. The musical scoring interface of claim 11, wherein the staff comprises:
a default setting; and
a user-defined setting.

13. The musical scoring interface of claim 12, wherein the default setting comprises:
two measures;
eighth note width columns;
five lines;
a treble clef;
upper and lower ledger areas; and
a repeat symbol.

14. The musical scoring interface of claim 12, wherein the user-defined setting includes:
setting a pitch range;
selecting a clef;
selecting meter; and
adding measures.

15. The musical scoring interface of claim 11, wherein the interface is provided at an Internet Web site.

16. The musical scoring interface of claim 11, wherein the interface is provided as an application on a local media device.

17. A musical scoring system, comprising:
a program of instructions comprising machine executable code for rendering a musical score based on a musical curve input from a user;
a processor that executes the program of instructions by reading the machine executable code;
an interface provided by the processor executing the program of instructions, wherein the user provides the musical curve input and wherein the processor renders the musical score, and wherein the processor operates to:
receive the user-provided musical curve input;
render a musical curve based on the user-provided musical curve input;
render notes on the musical curve to form the musical score in a form capable of playback; and
play back the musical score.

18. The system of claim 17, wherein the machine executable code of the program of instructions comprises code for play back of the musical score, comprising:
code to skip every other note in a single column of notes;
code to override the skip every other note code and skip a seventh note in the single column of notes; and
code to play a note associated with a curve segment traversing multiple columns at a single pitch for a duration equal to a number of columns traversed.

19. The system claim 18, wherein the machine executable code of the program of instructions includes code to play back the musical score according to an instrument selected by the user.

20. A computer readable storage medium comprising a program of instructions that when executed by a processor cause the processor to:
provide a musical scoring interface;
receive a user defined musical curve input;
render a musical curve based on the user defined musical curve input;
render notes on the musical curve to form a musical score capable of playback; and
play the musical score

21. The computer readable storage medium of claim 20, wherein the musical score comprises a curve segment defines as a single column with a plurality of pitches, and wherein the program of instructions, when executed by the processor further cause the processor to:
play every other note in the curve segment; and
skip a note at a seventh pitch of the curve segment.
